(19) United States
(12) Patent Application Publication
(10) Pub. No.: US 2026/0106759 A1
(43) Pub. Date: Apr. 16, 2026

(54) TRUSTLESS EXECUTION ENVIRONMENT CRYPTOGRAPHIC PROOFS

(71) Applicants: Lemon Inc., Grand Cayman (KY); Beijing Zitiao Network Technology Co., Ltd., Beijing (CN)

(72) Inventors: Mingshen Sun, Culver City, CA (US); Haobin Chen, Culver City, CA (US); Donghang Lu, Culver City, CA (US); Qiang Yan, Beijing (CN)

(21) Appl. No.: 18/917,158

(22) Filed: Oct. 16, 2024

(51) Int. Cl. H04L 9/32; G06F 21/57; H04L 9/08

(52) U.S. Cl. CPC H04L 9/3221; G06F 21/57; H04L 9/0861; H04L 9/321

(57) ABSTRACT

Methods, systems, and apparatus, including computer programs encoded on computer storage media, for using cryptographic proofs. One of the methods includes receiving a verification circuit and cryptographic proving key at a data processing system having a trusted execution environment (TEE); generating, using the cryptographic proving key, a cryptographic proof that indicates whether the TEE is correctly implemented; and providing, to a recipient system, the cryptographic proof.

### BACKGROUND

This specification relates to data processing. Confidential computing refers to a security and privacy protecting computation technique to protect data during processing, e.g., in a remote or cloud based environment. In many systems, data can be encrypted in storage and in transit, but not while in use in memory. Confidential computing protects data during processing by performing computation in a hardware-based trusted execution environment (TEE). A TEE can be a hardware processor segregated from external adversaries. The TEE can provide a protected area for code execution and data processing that is isolated from other system software including operating systems and applications.

The use of confidential computing allows for parties to collaborate on sensitive data using TEEs without exposing the sensitive data. For example, researchers can analyze sensitive user data across one or more institutions without exposing the individual personal data records, which helps maintain data privacy. Conventional TEEs rely on an assumption that the hardware providers correctly implement the TEEs. However, while the TEE hardware itself is trusted, conventionally the necessary software stack implementing the TEE, e.g., firmware, is not verified, opening a potential security vulnerability.

### SUMMARY

This specification describes technologies for allowing public verification that a TEE is correctly implemented. Specifically, the TEE is verified without requiring trust in the implementation or disclosure of the TEE implementation details, e.g., specific code used by the TEE implementor. While the hardware is trusted, the overall scope of trust is reduced by eliminating the need to also trust the software implementing the TEE. To provide this verification, cryptographic proofs, e.g., zero-knowledge proofs, are employed. The public user only needs to verify the zero knowledge proof to determine if the TEE is running in an expected manner.

As described in more detail below, a trusted third party can publish a formal TEE specification used by TEE implementers. The trusted third party then generates a zero-knowledge circuit implementing a verifier for the TEE based on the formal TEE specification. The verifier is deployed by the party implementing the TEE, e.g., a cloud-based data processing system. The verifier is used to generate a zero-knowledge proof. The public user can obtain the proof and a verification key from the trusted third party in order to verify the validity of the proof. Based on this, the public user can choose to trust the TEE implementation.

In general, one innovative aspect of the subject matter described in this specification can be embodied in methods that include the actions of receiving a verification circuit and cryptographic proving key at a data processing system having a trusted execution environment (TEE); generating, using the cryptographic proving key, a cryptographic proof that indicates whether the TEE is correctly implemented; and providing, to a recipient system, the cryptographic proof. Other embodiments of this aspect include corresponding computer systems, apparatus, and computer programs recorded on one or more computer storage devices, each configured to perform the actions of the methods. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

The subject matter described in this specification can be implemented in various implementations and may result in one or more of the following advantages. The use of zero-knowledge proofs provides a cryptographic solution for verifying expected behavior according to a formal TEE specification without requiring the disclosure of the implementation details of the TEE itself. The zero-knowledge proof provides a strong cryptographic guarantee that a TEE implementation is correct.

In some implementations, the systems and methods described in this specification can improve computer security, e.g., using zero-knowledge proofs, by moving a software portion of a TEE out of the trust boundary. This can reduce a likelihood that a TEE is not implemented correctly, e.g., is compromised or otherwise acting maliciously, without detection by a system relying on the TEE for confidential computing.

Additionally, the technologies described can allow parties to implement TEEs other than hardware vendors since their implementation of the TEE can be independently verified. Furthermore, because of the use of the zero-knowledge proof based on an abstraction of the instruction set used for the software implementing the TEE, the data processing system implementing the TEE need not reveal the actual implementation code to third parties. As long as the behavior of the code satisfies all the functions defined by the abstraction, then the implementation of the TEE is considered correct. Then the actual implementation code maybe can be treated as a commercial secret and the zero-knowledge proof will not leak the implementation code.

Since the abstraction of the instruction set is primarily a set of microcode firmware functions, it has a small size that requires little computational resources to derive a zero-knowledge circuit or to generate the corresponding proof as compared to other verification techniques. The details of one or more implementations of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 depicts an example environment in which a system uses zero-knowledge proofs as part of a verification process for a trusted execution environment (TEE).

FIG. 2 is a flow diagram of an example process for using a zero-knowledge proof.

FIG. 3 is a block diagram of an example computing system that can be used in connection with computer-implemented methods described in this specification.

Like reference numbers and designations in the various drawings indicate like elements.

### DETAILED DESCRIPTION

This specification discloses technologies for verifying the implementation of a TEE. Before a computing system of a public user requests data processing performed by a computing system implementing a TEE, the public user may want to verify the implementation of the TEE. For example, while the hardware processor of the TEE may be trusted, a set of software instructions may be used to implement the functions of the TEE. The described technologies allow for the implementation software to be tested to verify that the TEE is functioning as expected.

To test the implementation of the TEE, a verifier is deployed by a trusted third party computing system to a computing device implementing the TEE. The verifier system at the computing system implementing the TEE can use a cryptographic proof, e.g. a zero-knowledge proof, to indicate whether the recipient system of a public user can trust the verification process performed by the verifier system, e.g., that indicates whether the verification process was correctly executed, e.g., likely correctly executed.

For instance, a zero-knowledge proof can be data that indicates a method by which a first entity, e.g., the verifier system or prover, proves to another party, e.g., the recipient system corresponding to a public user that will use the TEE to perform confidential computing, that a statement is true. A zero-knowledge proof can avoid conveying information to the zero-knowledge proof verifier beyond the fact that the statement is true, increasing data privacy, security, or both. Use of a zero-knowledge proof can reduce a risk that the verifier system is compromised by a malicious actor or otherwise operating incorrectly, e.g., due to a software bug. The recipient system can then receive the zero-knowledge proof of the verification of the TEE implementation. When the recipient system determines that the zero-knowledge proof is verified, e.g., by evaluating the received zero-knowledge proof in view of an obtained verification key, the recipient system can determine to trust the implementation of the TEE for use in processing data.

The zero-knowledge proof can be any appropriate type of data that indicates whether the verification process was likely correctly executed. For instance, the zero-knowledge proof can be data that the verifier system has that indicates that the verification process was likely correctly executed and, when provided to the recipient system, can be used by the recipient system to verify the correctness of the execution. Although the zero-knowledge proof indicates that the verification process was likely correctly executed, the zero-knowledge proof is not necessarily a value that represents a likelihood. Instead, the zero-knowledge proof is a value that the recipient system uses to verify the verification process.

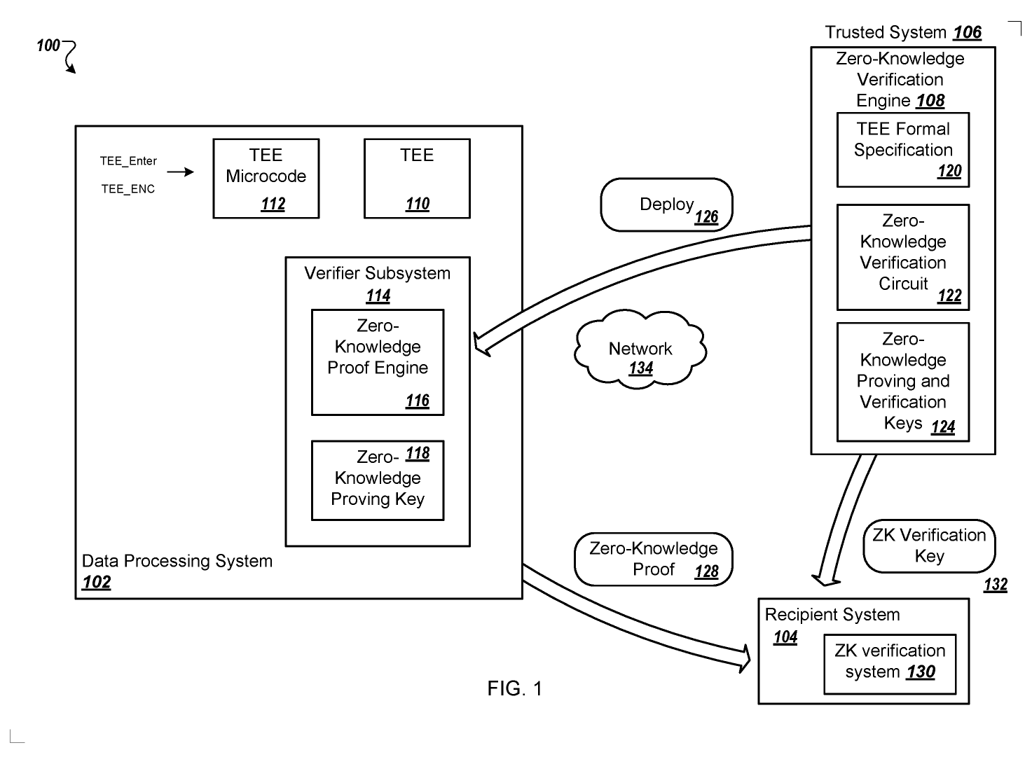

FIG. 1 depicts an example environment 100 in which a data processing system 102, e.g., a cloud-based system that implements a TEE for confidential computation, uses zero-knowledge proofs as part of a verification process for the implementation of the TEE. By providing a zero-knowledge proof to a recipient system 104, the data processing system 102 can increase trust in the data processing system since the recipient system 104 need not trust the implementation of the TEE on the data processing system.

The environment 100 also includes a trusted system 106. The trusted system 106 includes a zero-knowledge verification engine 108 that generates a zero-knowledge verification circuit 110 that is provided to the data processing system 102. The trusted system 106 is a trusted third party that is not a participant in the data processing requests, for example, a non-profit organization or other impartial body.

The data processing system 102 includes a TEE 110. The TEE 110 is segregated hardware on the data processing system 102, for example, a processor or area of a processor that is protected by encryption. As a result, data operations in the TEE cannot be read or tampered with by any code outside of the TEE. While the resulting hardware is trusted to operate as intended, implementing the TEE 110 requires a software layer to operate the TEE. This software stack 112 can be abstracted as a set of microcode extensions necessary to implement a valid TEE. The micro code extensions, for example, can include a microcode instruction called TEE encrypt that, when called, will cause the TEE to perform an encryption using a secret key inside of the TEE hardware.

The TEE 110 can be used to perform confidential computing. For example, two or more parties may wish to collaborate without revealing sensitive data. The data processing can be performed on the TEE 110, e.g., according to specified queries, algorithms, or other operations, in a manner that preserves data privacy and does not require trust between the collaborating parties.

The data processing system 102 also includes a verifier subsystem 114. The verifier subsystem 114 generates a zero-knowledge proof of the implementation of the TEE 110 based on a zero-knowledge verification circuit generated by the trusted system 106 and deployed on the data processing system 102.

The verifier subsystem 114 can generate a zero-knowledge proof that indicates whether the implementation of the TEE matches a public specification. The verifier subsystem 114 includes a zero-knowledge proof engine 116 and a zero-knowledge proving key 118.

A zero-knowledge proof can be a cryptographic primitive. A zero-knowledge proof can enable a prover, e.g., the verifier subsystem 114, to test if the software stack of the TEE correctly implements the instruction set by testing a set of microcode instructions needed to implement a valid TEE. For example, the verifier subsystem using the zero-knowledge circuit, received from the trusted system 106 as described below, triggers the set of microcode instructions and verifies if the behavior of the TEE is as expected.

The zero-knowledge proof engine 116 can use any appropriate zero-knowledge proof process, e.g., zero-knowledge succinct non-interactive argument of knowledge (“zk-SNARK”). For instance, the zero-knowledge proof engine 116 can implement a zero-knowledge proof circuit to verify that the TEE 110 is behaving correctly, e.g., honestly and not maliciously. Zk-SNARK is an example of a non-interactive zero-knowledge proof having a small proof size and short verification time. Various protocols can be used to implement a zk-SNARK proof system e.g., PLONK, GROTH16, bulletproof, etc.

The zero-knowledge proof engine 116 can use a zero-knowledge proving key 118 as part of the zero-knowledge proof process. For instance, the verifier subsystem 114 can maintain, in memory, the zero-knowledge proving key 118 that was previously obtained, as described in more detail below. The zero-knowledge proving key 118 can be specific to the data processing systems 102 implementing the TEE. The zero-knowledge proof engine 116 can use the zero-knowledge proving key 118 to generate the zero-knowledge proof.

The trusted system 106 includes zero-knowledge verification system 108. The zero-knowledge verification system 108 uses a TEE formal specification 120 to generate the zero-knowledge verification circuit 122 specific to the TEE 110. The TEE formal specification 120 is formed from an abstraction of microcode instructions to the TEE that would be necessary to implement a valid TEE, for example, encryption, decryption, memory access, etc. Thus, the formal specification can be generated without having to get access to the actual code used by the data processing system 102 to implement the TEE 110. The trusted system 106 defines the correct behavior of the TEE when each of these microcode instructions are triggered. The instructions can relate to operation of the CPU itself or the operations as a TEE that can be simulated to determine what the correct behavior should entail.

The zero-knowledge verification engine 108 generates the zero-knowledge verification circuit 122 based on this formal specification. The zero-knowledge verification circuit 122 specifies the instructions and correct operation in a manner that can be applied by a verifier system to generate a zero-knowledge proof. The resulting proof then indicates whether the TEE, as implemented by the data processing system, behaves as specified in the TEE formal specification 120. If the proof indicates that the implementation is correct, then the TEE can be considered valid by users such as the recipient system 104.

The zero-knowledge verification engine 108 also generates corresponding keys 124. The keys include a zero-knowledge proving key used by the verifier subsystem 114 of the processing system 102 to generate the zero-knowledge proof. The keys also include a zero-knowledge verification key used by the recipient system 104 to validate a received proof. The zero-knowledge proving key and the zero-knowledge verification key can be generated at any appropriate time. For instance, the keys can be generated at the same time or separately.

The trusted system 108 deploys 126 the zero-knowledge verification circuit 144 and the zero-knowledge proving key to the verifier subsystem 114 of the data processing system 102.

The recipient system 104 receives a zero-knowledge proof 128 from the data processing system 102. In some implementations, the verifier subsystem 114 generates a zero-knowledge proof each time the TEE is rebooted, after which it is stored until the TEE reboots again. The stored proof can then be provided upon request, e.g., from the recipient system 104. In some other implementations, the zero-knowledge proof can be generated on demand, e.g., in response to the request for the zero-knowledge proof from the recipient system 104.

The recipient system 104 can include a zero-knowledge proof verification engine 130. The zero-knowledge proof verification engine 130 verifies the received zero-knowledge proof. Verification of the zero-knowledge proof can use fewer computational resources than other types of verification performed on the data processing system, e.g., as part of the attestation process. For instance, zero-knowledge proof verification can use fewer computational cycles, less memory, less power, or a combination of two or more of these. In some examples, software code for the zero-knowledge proof verification engine 130 can be less complex than software needed to perform other forms of verification e.g., can include fewer lines of code.

The zero-knowledge proof verification engine 130 can use a zero-knowledge verification key 132 as part of the zero-knowledge proof verification process. The recipient system 104 can access the zero-knowledge verification key 132 at any appropriate time, and from the trusted system 106.

By using the zero-knowledge proof to verify the implementation of the TEE, the recipient system 104 can reduce a number of entities on which it relies, i.e., must trust. For instance, the recipient system 104 might need to trust the zero-knowledge proof process, e.g., the cryptographic proof process, but need not trust the verifier subsystem 114. As a result, the recipient system 104 can increase computer security; data privacy, e.g., by increasing a likelihood that the data processing system 102 performs the correct operations on any data the data processing system 102 received from the recipient system 104; or a combination of both.

When the zero-knowledge proof verification process passes, the recipient system 104 can determine that the implementation of the TEE 110 is correct. The recipient system 104 can therefore determine to use the data processing system 102 to perform data operations and treat the output results as correct. If the zero-knowledge proof verification process fails, the recipient system 104 can determine not to use the data processing system 102 and/or the TEE 110.

In examples in which the zero-knowledge proof verification process fails, the recipient system 104 can determine one or more operations to perform. These operations can include finding another data processing system and/or TEE to perform the data processing operations for the recipient system 104, e.g., finding another trusted hardware manufacturer; finding data processing system 102 to perform operations for the recipient system 104; performing one or more computer security operations, e.g., reporting the failure to another entity; or a combination of two or more of these.

The recipient system 104 can send any reports to a reporting system, e.g., a subsystem of the data processing system 102 or another system. The reporting system can be for a security entity, e.g., to which potential security concerns are reported for further analysis.

The recipient system 104 can perform one or more operations, such as transmitting a message to an entity, e.g., a security entity, indicating the failure; determining to stop communicating with the data processing system 102; or a combination of both. The message can include the failed zero-knowledge proof. In instances in which the zero-knowledge verification key 132 was accessed from a trusted source, providing the zero-knowledge proof to a security entity can enable the trusted system 106 to confirm the failure of the zero-knowledge proof.

The data processing system 102, the recipient system 104, and the trusted system 106, optionally including any subsystems, are examples of a system implemented as computer programs on one or more computers in one or more locations, in which the systems, components, and techniques described in this specification are implemented. In some examples, the recipient system 104 can include a single device, such as a personal computer, a mobile communication device, or another device that can send and receive data over a network 134. The network 134, such as a local area network (“LAN”), wide area network (“WAN”), the Internet, or a combination thereof, connects the data processing system 102, the recipient system 104, and the trusted system 106. The systems can use a single computer or multiple computers operating in conjunction with one another, including, for example, a set of remote computers deployed as a cloud computing service.

The data processing system 102 and the recipient system 104 can include several different functional components, including the verification system 114, the zero-knowledge proof engine 116, and the zero-knowledge proof verification engine 130. The verification system 114, the zero-knowledge proof engine 116, the zero-knowledge proof verification engine 130, or a combination of these, can include one or more data processing apparatuses, can be implemented in code, or a combination of both. For instance, each of the verification system 114, the zero-knowledge proof engine 116, and the zero-knowledge proof verification engine 130 can include one or more data processors and instructions that cause the one or more data processors to perform the operations discussed in this specification.

The various functional components of the data processing system 102 and the recipient system 104 can be installed on one or more computers as separate functional components or as different modules of a same functional component. For example, the components of the data processing system 102 and the recipient system 104 can be implemented as computer programs installed on one or more computers in one or more locations that are coupled to each through a network. In cloud-based systems for example, these components can be implemented by individual computing nodes of a distributed computing system.

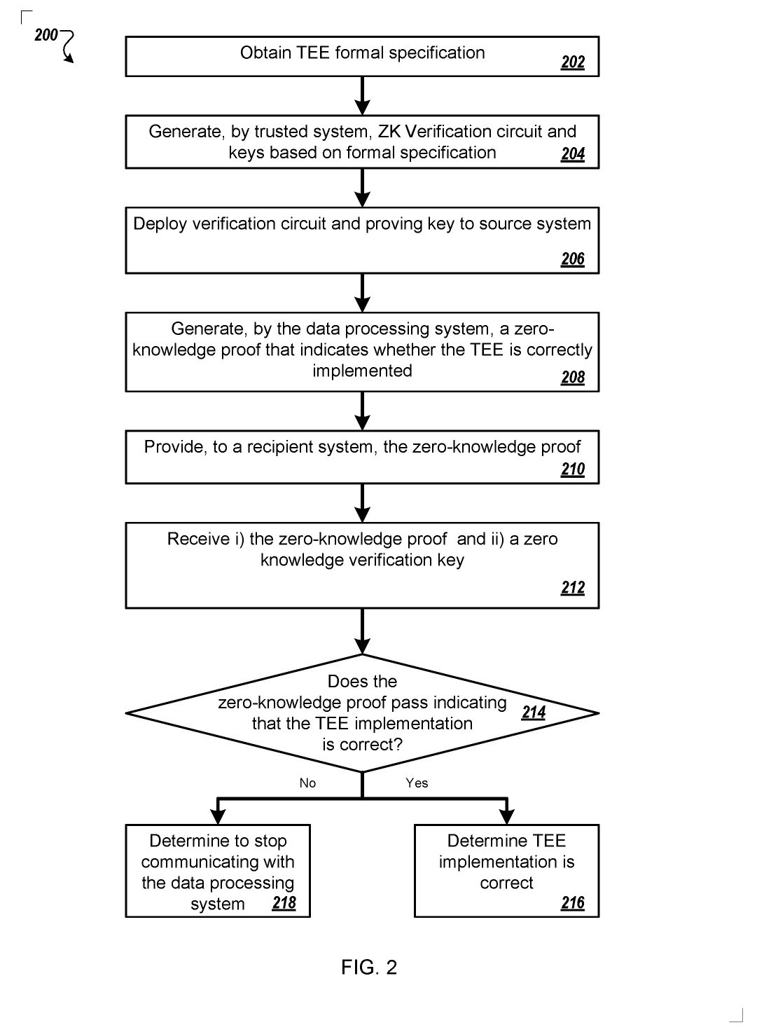

FIG. 2 is a flow diagram of an example process 200 for using a zero-knowledge proof. For example, various operations in the process 200 can be implemented by the verifier subsystem 114, the trusted system 106, and the recipient system 104 of the environment 100.

The trusted system obtains a TEE formal specification (202). The trusted system can generate the TEE formal specification based on a set of microcode instructions that a valid TEE must correctly implement, as described above. In some implementations, the trusted system receives the TEE formal specification from a third party source.

The trusted system generates a zero-knowledge verification circuit and keys based on the TEE formal specification (204). The zero-knowledge verification circuit specifies the microcode instructions and the expected execution results for each instruction by the TEE. The keys include a zero-knowledge proving key used with the circuit by a verification system to generate a zero-knowledge proof and a zero-knowledge verification key used by a recipient system to validate an obtained proof.

The trusted system deploys the zero-knowledge verification circuit and zero-knowledge proving key to a verifier subsystem of a data processing system implementing a TEE (206).

The verification subsystem of the data processing system generates a zero-knowledge proof that indicates whether the TEE is correctly implemented (208). Specifically, the verification subsystem generates, using a zero-knowledge proving key and a zero-knowledge proof engine, the zero-knowledge proof. The zero-knowledge proof engine can generate the zero-knowledge proof at any appropriate time. For instance, the zero-knowledge proof engine can generate the zero-knowledge proof each time the TEE is rebooted or in response to a request for a proof from a recipient system.

The data processing system provides the zero-knowledge proof to the recipient system (210). As described above, the proof can be provided in response to a request from a recipient system. The recipient system can be, for example, a system corresponding to a party that will potentially use the data processing system, e.g., to perform confidential computing.

The recipient system receives the zero-knowledge proof and the zero-knowledge verification key (212). The recipient system receives the zero-knowledge proof from the data processing system and the zero-knowledge verification key from the trusted system. For instance, the data processing system, or a component of the data processing system, can create a message that includes the zero-knowledge proof. Similarly, the trusted system can generate a message that includes the zero-knowledge verification key.

The recipient system determines whether the zero-knowledge proof passes, indicating that the TEE implementation is correct (214). The recipient system uses the zero-knowledge verification key to verify the zero-knowledge proof. If the proof indicates that the implementation is correct, the proof passes. If the proof indicates that the implementation is not correct, e.g., the microcode, when triggered, did not generate expected results, the proof fails.

In response to determining that the proof passes, the recipient system determines that the TEE is implemented correctly (216). The recipient system can use the data processing system to perform confidential computation on supplied data.

In response to determining that the proof does not pass, the recipient system determines that the TEE is not implemented correctly and may be a security risk (218). The recipient system may choose not to use the TEE or the data processing system to perform confidential computation on supplied data. Furthermore, the recipient system can perform one or more additional operations. These operations can include determining to stop communicating with the data processing system, sending a notification to a reporting system, e.g., a security system, indicating that the proof did not pass, another appropriate operation, or a combination of two or more of these.

In some implementations, the systems and methods described in this specification can use a cryptographic proof other than a zero-knowledge proof. For instance, the verifier system and recipient system can use another type of interactive proof, such as a reduction proof, or a private-key cryptosystem.

In this specification, the term “database” is used broadly to refer to any collection of data: the data does not need to be structured in any particular way, or structured at all, and it can be stored on storage devices in one or more locations. A database can be implemented on any appropriate type of memory.

In this specification the term “engine” is used broadly to refer to a software-based system, subsystem, or process that is programmed to perform one or more specific functions. Generally, an engine will be implemented as one or more software modules or components, installed on one or more computers in one or more locations. In some instances, one or more computers will be dedicated to a particular engine. In some instances, multiple engines can be installed and running on the same computer or computers.

This specification uses the term “configured to” in connection with systems, apparatus, and computer program components. That a system of one or more computers is configured to perform particular operations or actions means that the system has installed on it software, firmware, hardware, or a combination of them that in operation cause the system to perform those operations or actions. That one or more computer programs is configured to perform particular operations or actions means that the one or more programs include instructions that, when executed by data processing apparatus, cause the apparatus to perform those operations or actions. That special-purpose logic circuitry is configured to perform particular operations or actions means that the circuitry has electronic logic that performs those operations or actions.

A number of implementations have been described. Nevertheless, it will be understood that various modifications can be made without departing from the spirit and scope of the disclosure. For example, various forms of the flows shown above can be used, with operations re-ordered, added, or removed.

Implementations of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Implementations of the subject matter described in this specification can be implemented as one or more computer programs, i.e., one or more modules of computer program instructions encoded on a tangible non-transitory program carrier for execution by, or to control the operation of, a data processing apparatus. Alternatively or in addition, the program instructions can be encoded on an artificially-generated propagated signal, e.g., a machine-generated electrical, optical, or electromagnetic signal, that is generated to encode information for transmission to a suitable receiver apparatus for execution by a data processing apparatus. One or more computer storage media can include a machine-readable storage device, a machine-readable storage substrate, a random or serial access memory device, or a combination of one or more of them.

The term “data processing apparatus” refers to data processing hardware and encompasses all kinds of apparatus, devices, and machines for processing data, including by way of example a programmable processor, a computer, or multiple processors or computers. The apparatus can be or include special purpose logic circuitry, e.g., a field programmable gate array (“FPGA”) or an application-specific integrated circuit (“ASIC”). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, a module, a software module, a script, or code, can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can be performed by, and apparatus can also be implemented as, special purpose logic circuitry, e.g., a field programmable gate array (“FPGA”) or an application-specific integrated circuit (“ASIC”).

Computers suitable for the execution of a computer program include, by way of example, general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. A computer can be embedded in another device, e.g., a mobile telephone, a smart phone, a headset, a personal digital assistant (“PDA”), a mobile audio or video player, a game console, a Global Positioning System (“GPS”) receiver, or a portable storage device, e.g., a universal serial bus (“USB”) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, implementations of the subject matter described in this specification can be implemented on a computer having a display device, e.g., a liquid crystal display (“LCD”), an organic light emitting diode (“OLED”) or other monitor, for displaying information to the user and a keyboard and a pointing device, e.g., a mouse or a trackball or a touchscreen, by which the user can provide input to the computer. Other kinds of devices can be used to provide for interaction with a user as well. For example, feedback provided to the user can be any form of sensory feedback, e.g., visual feedback, auditory feedback, or tactile feedback; and input from the user can be received in any form, including acoustic, speech, or tactile input. In some examples, a computer can interact with a user by sending documents to and receiving documents from a device that is used by the user; for example, by sending web pages to a web browser on a user’s device in response to requests received from the web browser.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other. In some implementations, a server transmits data, e.g., an Hypertext Markup Language (“HTML”) page, to a user device, e.g., for purposes of displaying data to and receiving user input from a user device, which acts as a client. Data generated at the user device, e.g., a result of user interaction with the user device, can be received from the user device at the server.

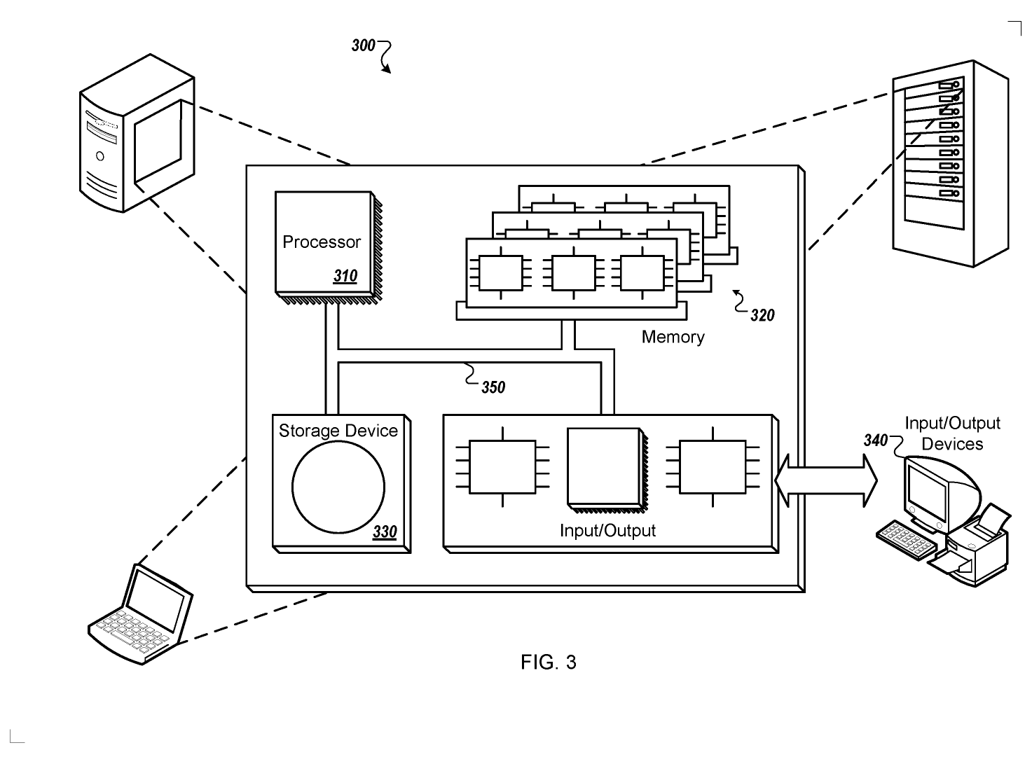

An example of one such type of computer is shown in FIG. 3, which shows a schematic diagram of a computer system 300. The computer system 300 can be used for the operations described in association with any of the computer-implemented methods described previously, according to some implementations. The computer system 300 includes a processor 310, a memory 320, a storage device 330, and an input/output device 340. Each of the components 310, 320, 330, and 340 are interconnected using a system bus 350. The processor 310 is capable of processing instructions for execution within the computer system 300. In one implementation, the processor 310 is a single-threaded processor. In another implementation, the processor 310 is a multi-threaded processor. The processor310 is capable of processing instructions stored in the memory 320 or on the storage device 330 to display graphical information for a user interface on the input/output device 340.

The memory 320 stores information within the computer system 300. In some implementations, the memory 320 is a computer-readable medium. In some implementations, the memory 320 is a volatile memory unit. In some implementations, the memory320 is a non-volatile memory unit.

The storage device 330 is capable of providing mass storage for the computer system 300. In some implementations, the storage device 330 is a computer-readable medium. In some implementations, the storage device 330 can be a floppy disk device, a hard disk device, an optical disk device, or a tape device.

The input/output device 340 provides input/output operations for the computer system 300. In some implementations, the input/output device 340 includes a keyboard, a pointing device, a touchscreen, or a combination of these. In some implementations, the input/output device 340 includes a display unit for displaying graphical user interfaces. In some implementations, the input/output device 340 includes a microphone, a speaker, or a combination of both.

In addition to the embodiments of the attached claims and the embodiments described above, the following embodiments are also innovative:

Embodiment 1 is a method, the method comprising: receiving a verification circuit and cryptographic proving key at a data processing system having a trusted execution environment (TEE); generating, using the cryptographic proving key, a cryptographic proof that indicates whether the TEE is correctly implemented; and providing, to a recipient system, the cryptographic proof.

Embodiment 2 is the method of embodiment 1, wherein the verification circuit is generated by a trusted third party based on a TEE formal specification.

Embodiment 3 is the method of any one of embodiments 1 through 2, wherein the verification circuit defines expected behavior of the TEE in response to triggering particular microcode instructions used to implement the TEE.

Embodiment 4 is the method of any one of embodiments 1 through 3, wherein the generating the cryptographic proof is triggered each time the TEE is rebooted.

Embodiment 5 is the method of any one of embodiments 1 through 4, wherein providing the cryptographic proof comprises providing the cryptographic proof that comprises a cryptographic primitive and enables the recipient system to verify, using the cryptographic primitive, the verification process for the attestation data.

Embodiment 6 is the method of any one of embodiments 1 through 5, wherein the cryptographic proof comprises a zero-knowledge proof.

Embodiment 7 is the method of any one of embodiments 1 through 6, wherein providing the cryptographic proof comprises providing, to the recipient system, the cryptographic proof to cause the recipient system to verify the cryptographic proof using a cryptographic verification key.

Embodiment 8 is the method of any one of embodiments 1 through 7, wherein providing the cryptographic proof comprises providing, to the recipient system, the cryptographic proof to cause the recipient system to verify the cryptographic proof using the cryptographic verification key that was previously provided to the recipient system by a trusted third party system that generated the circuit.

Embodiment 9 is the method of any one of embodiments 1 through 8, further comprising generating, by a trusted third party system, the cryptographic proving key and the cryptographic verification key.

Embodiment 10 is a system comprising: one or more computers and one or more storage devices storing instructions that are operable, when executed by the one or more computers, to cause the one or more computers to perform the method of any one of embodiments 1 to 9.

Embodiment 11 is a computer storage medium encoded with a computer program, the program comprising instructions that are operable, when executed by data processing apparatus, to cause the data processing apparatus to perform the method of any one of embodiments 1 to 9.

While this specification contains many specific implementation details, these should not be construed as limitations on the scope of what may be claimed, but rather as descriptions of features that may be specific to particular implementations. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some instances be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the implementations described above should not be understood as requiring such separation in all implementations, and it should be understood that the described program components and systems can generally be integrated together in a single software product or packaged into multiple software products.

In each instance where an HTML file is mentioned, other file types or formats may be substituted. For instance, an HTML file may be replaced by an XML, JSON, plain text, or other types of files. Moreover, where a table or hash table is mentioned, other data structures, such as spreadsheets, relational databases, or structured files, may be used.

Particular implementations of the invention have been described. Other implementations are within the scope of the following claims. For example, the operations recited in the claims, described in the specification, or depicted in the figures can be performed in a different order and still achieve desirable results. In some implementations, multitasking and parallel processing may be advantageous.

1. A computer-implemented method comprising:
receiving a verification circuit and cryptographic proving key at a data processing system having a trusted execution environment (TEE);
generating, using the cryptographic proving key, a cryptographic proof that indicates whether the TEE is correctly implemented; and
providing, to a recipient system, the cryptographic proof.

2. The method of claim 1, wherein the verification circuit is generated by a trusted third party based on a TEE formal specification.

3. The method of claim 1, wherein the verification circuit defines expected behavior of the TEE in response to triggering particular microcode instructions used to implement the TEE.

4. The method of claim 1, wherein the generating the cryptographic proof is triggered each time the TEE is rebooted.

5. The method of claim 1, wherein providing the cryptographic proof comprises providing the cryptographic proof that comprises a cryptographic primitive and enables the recipient system to verify, using the cryptographic primitive, the verification process for the attestation data.

6. The method of claim 1, wherein the cryptographic proof comprises a zero-knowledge proof.

7. The method of claim 1, wherein providing the cryptographic proof comprises providing, to the recipient system, the cryptographic proof to cause the recipient system to verify the cryptographic proof using a cryptographic verification key.

8. The method of claim 7, wherein providing the cryptographic proof comprises providing, to the recipient system, the cryptographic proof to cause the recipient system to verify the cryptographic proof using the cryptographic verification key that was previously provided to the recipient system by a trusted third party system that generated the circuit.

9. The method of claim 4, further comprising generating, by a trusted third party system, the cryptographic proving key and the cryptographic verification key.

10. The method of claim 1, wherein:
the data processing system comprises trusted hardware that is configured to perform one or more data computations for the recipient system.

11. A system comprising:
one or more computers and one or more storage devices storing instructions that are operable, when executed by the one or more computers, to cause the one or more computers to perform operations comprising:
receiving, at a data processing system, a verification circuit and cryptographic proving key at a data processing system having a trusted execution environment (TEE);
generating, at the data processing system and using the cryptographic proving key, a cryptographic proof that indicates whether the TEE is correctly implemented; and
providing, to a recipient system, the cryptographic proof.

12. The system of claim 11, wherein the verification circuit is generated by a trusted third party based on a TEE formal specification.

13. The system of claim 11, wherein the verification circuit defines expected behavior of the TEE in response to triggering particular microcode instructions used to implement the TEE.

14. The system of claim 11, wherein the generating the cryptographic proof is triggered each time the TEE is rebooted.

15. The system of claim 11, wherein providing the cryptographic proof comprises providing the cryptographic proof that comprises a cryptographic primitive and enables the recipient system to verify, using the cryptographic primitive, the verification process for the attestation data.

16. The system of claim 11, wherein the cryptographic proof comprises a zero-knowledge proof.

17. The system of claim 11, wherein providing the cryptographic proof comprises providing, to the recipient system, the cryptographic proof to cause the recipient system to verify the cryptographic proof using a cryptographic verification key.

18. The system of claim 17, wherein providing the cryptographic proof comprises providing, to the recipient system, the cryptographic proof to cause the recipient system to verify the cryptographic proof using the cryptographic verification key that was previously provided to the recipient system by a trusted third party system that generated the circuit.

19. The system of claim 4, further comprising generating, by a trusted third party system, the cryptographic proving key and the cryptographic verification key.

20. One or more non-transitory computer storage media encoded with computer program instructions that when executed by one or more computers cause the one or more computers to perform operations comprising:
receiving a verification circuit and cryptographic proving key at a data processing system having a trusted execution environment (TEE);
generating, using the cryptographic proving key, a cryptographic proof that indicates whether the TEE is correctly implemented; and
providing, to a recipient system, the cryptographic proof.
